(19) United States
(12) Patent Application Publication
(10) Pub. No.: US 2010/0221077 A1
(43) Pub. Date: Sep. 2, 2010

(54) TAP WITH CHIP BREAKING CHAMFER

(75) Inventors: Derek J. Nash, Huntersville, NC (US); Matthew S. Larson, Cornelius, NC (US)

Correspondence Address: MOORE & VAN ALLEN PLLC, P.O. BOX 13706, Research Triangle Park, NC, 27709, US

(73) Assignee: Irwin Industrial Tool Company, Huntersville, NC (US)

(21) Appl. No.: 12/394,638

(22) Filed: Feb. 27, 2009

(51) Int. Cl. B23B 35/00; B23D 77/00

(52) U.S. Cl. 408/1 R; 408/222

(57) ABSTRACT

The tap comprises a shank portion and a threaded portion connected to the shank portion. The threaded portion includes a plurality of lands separated by flutes where each of the lands has threads formed thereon. Each of the plurality of lands including a chamfer formed at an end thereof where the chamfer is formed with a cutting edge and a heel edge. The cutting edge is formed with a first positive relief angle and the heel edge is formed with a second positive relief angle.

### BACKGROUND OF THE INVENTION

Taps are commonly used to cut internal threads. A typical tap consists of a an elongated blank having external threads formed on one end of the blank and a connector such as driving square on the other end of the blank. The connector is gripped by a turning tool such as a tap wrench to rotate the tap such the threads cut an internally threaded bore. The threads of the tap are interrupted by channels or flutes that create cutting edges on the thread profile and provide spaces for chips and air and cutting fluid passages. The flutes may be straight, tapered, spiral or helical. The threads are typically chamfered at their distal end to distribute the cutting action over several teeth. The chamfer is created by cutting away and relieving the crest of the first few teeth. The chamfer includes a radial relief that is the gradual decrease in land height from the cutting edge to heel on the chamfer to provide radial clearance for the cutting edge.

Such taps are used to create internal threads by rotating the tap forward a certain distance and then reversing the tap so that chips created during the forward rotation can be cleared from the flutes. The direction of rotation is reversed to break and clear chips to maintain lower torques on the forward rotation of the tap. If the torque applied to the tap becomes too large, the tap can break.

Hand taps are generally manufactured from High Carbon Steel or High Speed Steel. For machine taps the geometry of the tap can be optimized for tapping efficiency in particular materials because the machine tapping process can be tightly controlled. Because the machine process can be tightly controlled and optimized many machine tap processes can be run without reversing the tap.

With hand tapping, however, the material that is bored and the application of torque to the tap can vary greatly such that a hand tap must be able to perform well under a wide variety of conditions. For hand taps, a variety of techniques have been developed to minimize the amount of torque needed on the forward turn to prevent tap breakage.

### SUMMARY OF THE INVENTION

The tap comprises a shank portion and a threaded portion connected to the shank portion. The threaded portion includes a plurality of lands separated by flutes where each of the lands has threads formed thereon. Each of the plurality of lands including a chamfer formed at an end thereof where the chamfer is formed with a cutting edge and a heel edge. The cutting edge is formed with a first positive radial relief and the heel edge is formed with a second positive radial relief.

### BRIEF DESCRIPTION OF THE DRAWINGS

FIG. 1 is a side view of an embodiment of the tap of the invention.

FIGS. 2 and 3 are section views showing a prior art tap.

FIGS. 4 and 5 are section views taken along line 4-4 of FIG. 1.

FIG. 6 is a graph showing the test results of the performance of the tap of the invention compared to a tap with an eccentric relief.

### DETAILED DESCRIPTION OF PREFERRED EMBODIMENTS OF THE INVENTION

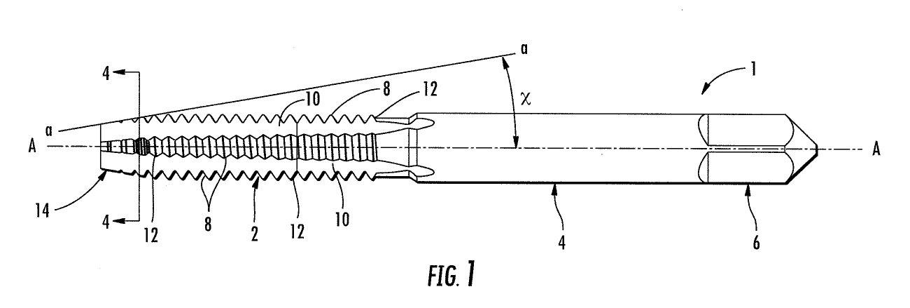

The chip breaking chamfer of the invention will be described with respect to the embodiment of the tap shown generally at 1 in FIG. 1. The tap 1 comprises a threaded portion 2 having a threaded length that is rotated into a part to create the internal threaded bore. The threaded portion 2 is connected to a shank 4 that has a driving portion 6. The driving portion 6 is configured to be releasably gripped by a turning tool such as a tap wrench such that the turning tool can apply a torque to the tap 1. In the illustrated embodiment the driving portion 6 is a square having four flat faces although other configurations of a driving portion including a female receptacle may be used.

The threaded portion 2 includes a plurality of threaded lands 8 that are separated by flutes 10. The lands 8 are formed with threads 12 that create and follow the internal threads formed in the part being tapped. In the illustrated embodiment the flutes 10 are straight although tapered, spiral or helical flutes may be used.

The end of the threaded portion 2 is formed with a chamfer 14. The chamfer 14 is the tapering of the threads at the end of each land 8 formed by cutting away and relieving the crest of the first few teeth to distribute the cutting action over several teeth. The chamfer angle is represented by line a-a and is the angle α formed between the chamfer and the longitudinal axis A-A of the tap measured in an axial plane at the cutting edge. The illustrated tap is a semi-bottoming tap although the chamfer may be formed as a plug tap, taper tap, bottoming tap or other shape.

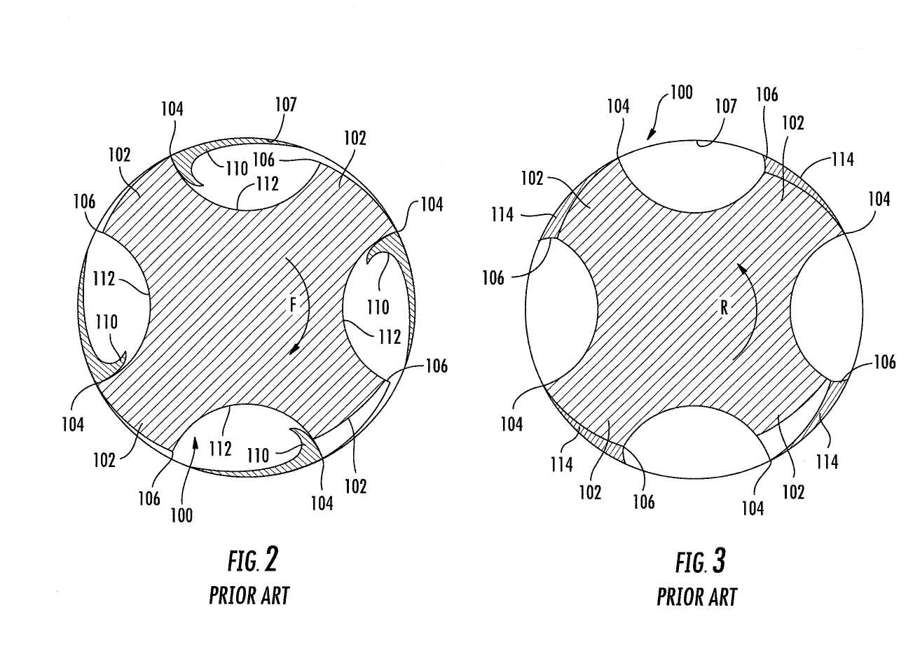

FIG. 2 shows a cross section of a prior art tap 100 where the lands 102 are provided with a relief. A relief is the removal of material behind each of the cutting edges 104 to provide clearance between the interior wall 107 of the bore formed in the part being threaded and the threaded land 102. In the illustrated embodiment the relief is an eccentric relief that is a radial relief starting at the cutting edge 104 and continuing to heel 106. FIG. 2 shows the tap as it makes the forward turn in the direction of arrow F. As the tap turns in the direction of arrow F the cutting edges 104 are the leading edges and create chips 110 in the area of flutes 112.

Referring to FIG. 3, the tap 100 is shown as it makes the reverse turn in the direction of arrow R. As the tap is reversed, the heel 106 becomes the leading edge. The inventors of the present invention determined that because the heel 106 has a negative relief, the heel does not perform well as a cutting edge. Because the heel is not a good cutting edge, portions of the chips created on the forward turn are not cut from the part on the reverse turn (as represented by shaded area 114). This material can become wedged between the lands 102 and the side of the threaded bore. The wedged material 114 can prevent the tap from turning such that as the user applies increasing torque to the tap to reverse the tap, the tap can break. The inventors of the present invention determined that the probability of breaking a tap in the reverse direction is practically equal to that in the forward direction.

Another type of land is known as the flatted land relief. This relief flattens the side of the land to create a more acute heel edge. The inventors discovered that because the flattened land removes material from behind the heel edge and cutting edge, the edges are prone to breakage because of the reduced support provided behind the edges.

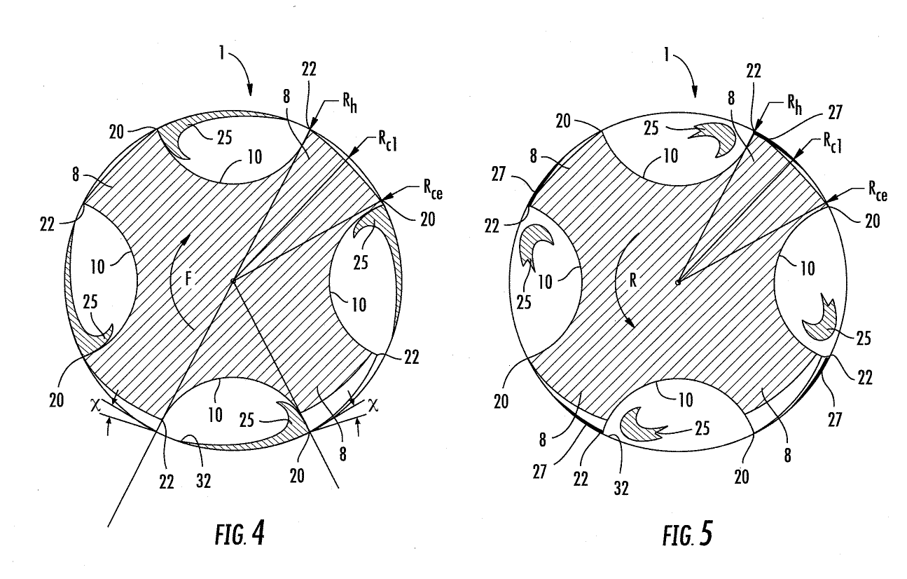

The tap of the invention improves chip cutting in the reverse direction yet provides strong land edges. A cross section of the embodiment of the tap of the invention is shown in FIGS. 4 and 5. In the tap of the invention both the cutting edge 20 and the heel edge 22 are formed with a positive radial relief. A positive radial relief means that the outer surface of the land curves toward the center of the tap such that clearance between the land and the bore increases as the land moves away from the edge of the tap. The heel edge provided with a positive radial relief is a much more effective cutting edge than is known in prior art devices. Because the heel edge is a more effective cutting edge, less material is left along the wall when the tap is reversed. As a result the material does not wedge between the lands and the side of the hole and breakage of the tap in the reverse direction is minimized.

Each land has a cutting edge 20 at a first radius R_{ce} that is the radial distance from the longitudinal axis of the blade to the cutting edge. Each land also has a heel edge 22 at a second radius Rₕ that is the radial distance from the longitudinal axis of the blade to the heel edge. The center of the land is positioned at a third radius R_{cl} that is the radial distance from the longitudinal axis of the blade to the center of the land at a point midway between the cutting edge and the heel edge. The three radii are selected such that R_{ce}>Rₕ>R_{cl}. Between R_{ce} and R_{cl} the radius of the land gradually decreases from R_{ce} to R_{cl}. Between Rₕ and R_{cl} the radius of the land gradually decreases from Rₕ to R_{cl}. Because the radial distance to the center of the land is less than the distance to both the cutting edge and the heel edge, both the cutting edge and the heel edge have a positive radial relief. The relief angle α is defined as the compliment of the angle formed between a line tangent to the relieved surface at the cutting edge and a radial line to the same point. A relief angle is formed at both the cutting edge 20 and the heel edge 22. In one preferred embodiment the relief angle on both the cutting edge 20 and heel edge 22 is less than 10°. In a preferred embodiment the relief angle on both the cutting edge 20 and heel edge 22 is 2° to 8°. Using relief angles in the ranges described above along with a gradual decrease in the radii R_{ce}, Rₕ, and R_{cl} combined with smooth transitions between the different radii provides effective cutting edges and durability of the tap.

The positive relief on the heel edge allows the heel edge to make cleaner and closer cuts of the chips on the reverse turn to minimize the amount of material left between the lands and the bore, thereby minimizing wedging and binding of the tap in the bore. As a result, less torque needs to be applied to the tap to reverse the tap in the bore which minimizes the probability that the tap will break on reversal. Because the lands are formed with a curved outer face extending between the cutting edge and the center of the land and the heel edge and the center of the land, more material supports the cutting edge and the heel edge than with a flatted land relief. Thus, the tap of the invention is less susceptible to failure than known taps.

In operation of the tap of the invention, the tap 1 is first rotated in the forward direction as represented by arrow F in FIG. 4. As the tap turns in the direction of arrow F the cutting edges 20 are the leading edges and create chips 25 in the area of flutes 10. Referring to FIG. 5, tap 1 is shown as it makes the reverse turn in the direction of arrow R. As the tap is reversed, the heel 22 becomes the leading edge. Because the heel 22 has a positive relief, the heel 22 performs well as a cutting edge. Because the heel 22 is a good cutting edge, the chips created on the forward turn are cut from the part on the reverse turn (as represented by shaded area 25 in FIG. 5). This material is ejected through the flutes 10. As a result, the amount of material 27 that remains that can become wedged between the lands 8 and the side 32 of the threaded bore is minimized. Because less material is left along the wall, less turning force is required to turn the tap in the reverse direction. With the application of lower torques, the tap is less likely to break.

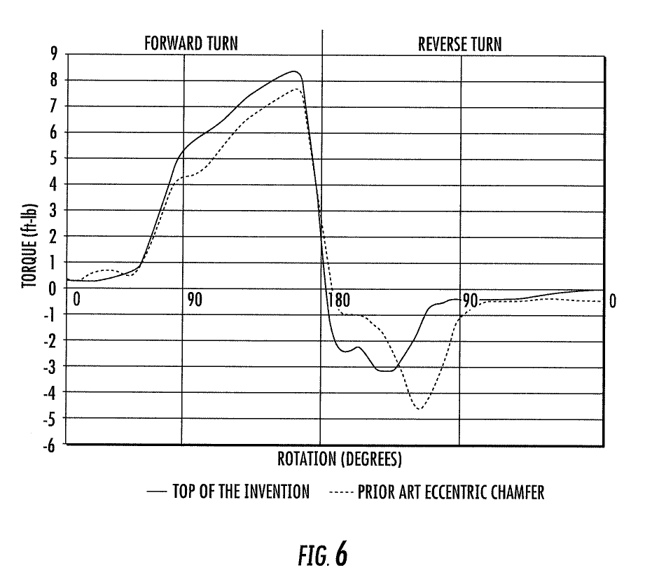

Referring to FIG. 6, a graph is shown that compares the test results of an eccentric chamfer tap with the tap of the invention. The graph plots the torque required to turn the tap along the y-axis against the angle of rotation of the tap along the x-axis. As is evident, the torque required to turn the tap increases as the tap is turned in the forward direction from zero to 180 degrees. As the tap is turned in the reverse direction from 180 degrees to zero degrees, the torque required to turn the tap increases to its greatest amount as the tap is initially reversed and then the torque gradually decreases as the tap is reversed out of the bore. The torque required to turn a traditional eccentric tap is shown in dashed line and the torque required to turn the tap of the invention is shown in solid line. In the forward direction there is little difference in the force required to turn the tap. In the reverse direction, the torque required to turn the tap of the invention is significantly less than the torque required to turn a traditional eccentric tap. In the reverse direction the force to turn the tap of the invention is approximately 60% of the force required to turn the eccentric tap. The graph of FIG. 6 shows a generally smaller reverse torque than forward torque, however, with an eccentric tap this can vary with the material and tap operation to make the torques more equal. In this situation the chip breaking chamfer of the invention is very important in reducing reverse torque. Thus, the overall durability of the tap of the invention is increased. While the radial relief provided on the tap of the invention is particularly useful for hand taps, such a design may also be used with machine taps if desired.

While embodiments of the invention are disclosed herein, various changes and modifications can be made without departing from the spirit and scope of the invention as set forth in the claims. One of ordinary skill in the art will recognize that the invention has other applications in other environments. Many embodiments are possible.

1. A tap comprising:
a shank portion;
a threaded portion having a longitudinal axis is connected to the shank portion, said threaded portion including a plurality of lands separated by a flute;
each of said plurality of lands including a chamfer formed at an end thereof, said chamfer being formed with a cutting edge and a heel edge, said cutting edge formed with a first positive relief angle of less than 10 degrees and said heel edge formed with a second positive relief angle of less than 10 degrees.

2. The tap of claim 1 further including a driving portion on said shank adapted to be releasably engaged by a turning tool.

3. The tap of claim 1 wherein each of said lands have threads formed thereon.

4. The tap of claim 1 wherein the cutting edge is located at a first radius from the longitudinal axis and said heel edge is located at a second radius from the longitudinal axis, said first radius being different than said second radius.

5. The tap of claim 4 wherein each of said plurality of lands includes a center located at a third radius from said longitudinal axis, wherein said third radius is less than said first radius and second radius.

6. The tap of claim 5 wherein the center of each of the lands is midway between the cutting edge and the heel edge.

7. The tap of claim 5 wherein the radius of the plurality of lands decreases from said first radius to said third radius.

8. The tap of claim 5 wherein the radius of the plurality of lands decreases from said second radius to said third radius.

9. A method of tapping a part comprising:
providing a shank portion having a longitudinal axis and a threaded portion connected to the shank portion, said threaded portion including a plurality of lands separated by a flute where each of said plurality of lands including a chamfer formed at an end thereof, said chamfer being formed with a cutting edge and a heel edge, said cutting edge formed with a first positive relief angle and said heel edge formed with a second positive relief angle;
rotating said tap in a first direction such that said cutting edge is a leading edge; and
rotating said tap in a second direction such that said heel edge is the leading edge.

10. A tap comprising:
a shank portion;
a threaded portion having a longitudinal axis is connected to the shank portion, said threaded portion including a plurality of lands separated by a flute;
each of said plurality of lands including a chamfer formed at an end thereof, said chamfer being formed with a cutting edge and a heel edge, said cutting edge formed with a first positive relief angle of 2 to 8 degrees and said heel edge formed with a second positive relief angle of 2 to 8 degrees; and
the cutting edge is located at a first radius from the longitudinal axis and said heel edge is located at a second radius from the longitudinal axis, and a center located at a third radius from said longitudinal axis, wherein said third radius is less than said first radius and second radius.

11. The tap of claim 10 wherein the radius of the plurality of lands gradually decreases from said first radius to said third radius.

12. The tap of claim 10 wherein the radius of the plurality of lands gradually decreases from said second radius to said third radius.
